(19) United States
(12) Patent Application Publication
(10) Pub. No.: US 2013/0002553 A1
(43) Pub. Date: Jan. 3, 2013

(54) CHARACTER ENTRY APPARATUS AND ASSOCIATED METHODS

(75) Inventor: Ashley Colley, Oulu (FI)

(73) Assignee: NOKIA CORPORATION, Espoo (FI)

(21) Appl. No.: 13/172,576

(22) Filed: Jun. 29, 2011

(51) Int. Cl. G06F 3/033; G06F 3/01

(52) U.S. Cl. 345/161; 345/156

(57) ABSTRACT

An apparatus comprising:
at least one processor; and
at least one memory including computer program code,
the at least one memory and the computer program code configured to, with the at least one processor, cause the apparatus to perform at least the following:
denote, as a base character string, a received character string entered using a user interface of an electronic device; and
iteratively perform the actions of:
   determining one or more extension character strings associated with the base character string such that each of the one or more extension character strings at least
   comprises the denoted base character string and one or more respective additional characters, or
   is semantically related to the denoted base character string;
   providing one or more said extension character strings for selection;
   enabling selection of a particular determined extension character string; and
   denoting the selected particular extension character string as the base character string for the subsequent iteration level; or
   selecting the particular determined extension character string as an input character string.

### TECHNICAL FIELD

The present disclosure relates to the field of user interfaces for character entry, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and can also include tablet computers.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Electronic devices may enable character input (which may not necessarily be Roman alphabet characters such as those used in English), for example, to write a text message or email. Conventional solutions provide a keyboard arrangement with a number of keys, wherein each key corresponds to one or more characters. Other solutions such as handwriting recognition have also been explored.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus, the apparatus comprising:
at least one processor; and
at least one memory including computer program code,
the at least one memory and the computer program code configured to, with the at least one processor, cause the apparatus to perform at least the following:
denote, as a base character string, a received character string entered using a user interface of an electronic device; and
iteratively perform the actions of:
   determining one or more extension character strings associated with the base character string such that the one or more extension character strings comprise the denoted base character string and one or more respective additional characters;
   providing one or more said extension character strings for selection;
   enabling selection of a particular determined extension character string; and
   denoting the selected particular extension character string as the base character string for the subsequent iteration level; or
   selecting the particular determined extension character string as an input character string.

Progressively building up a character string for input in iterations, or stages, may allow a desired character string to be entered with less typing. At each iteration the number of extension characters available for selection may be kept small enough to enable easier selection (e.g. avoiding scrolling long lists). This may result in a more intuitive and simple user interface. This may enable the size of the user interface (e.g. touch screen) to be reduced.

A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark.

A character string may comprise a series of characters in a particular order.

An extension character string may comprise a combination of one or more of:
a word; a sentence; a phrase; a free morpheme; a bound morpheme; a root character string; a stem character string; an affix; a prefix; a suffix;
a complete character string stored in a dictionary (for example a stored word or abbreviation such as ‘e.g.’, ‘lol’;
an incomplete character string, the incomplete character string and additional characters forming a complete character string stored in a dictionary; and
a common character string, the common character strings being common to at least two complete character strings stored in a dictionary (e.g. the character string ‘manag’ where the dictionary comprises the complete character strings ‘manage’ and ‘managing’).

A complete extension character string may be a shortest complete extension character string, wherein each shortest complete extension character string does not comprise another complete extension character string and one or more additional characters.

Using common character strings enables words may allow the free morpheme (root or stem) (e.g. ‘manag’) and the bound morpheme (e.g. inflectional or derivational morpheme) (e.g. ‘ing’, ‘ed’) of an inflected word (e.g. ‘managing’, ‘managed’) to be entered separately. For example, an extension character string may comprise a stem base character string and additional characters corresponding to a bound morpheme. This may make text entry for inflecting, or fusional, languages (e.g. German, Latin, Greek) easier and more intuitive, as when the base character string corresponds to a root, the user may be presented with a list of extension character strings corresponding to inflected forms of the stem base character string. It will be appreciated that this will be advantageous particularly when the end of the stem changes depending on the bound morpheme (e.g. the inflected word ‘managing’ does not have the ‘e’ of the basis word ‘manage’) This may be more intuitive as the words are constructed in semantic units.

The base character string may form the beginning characters of each corresponding determined extension character string. For example, the respective additional characters may be appended to the end of the base character string to form the corresponding extension character string. In this case, it will be appreciated that the beginning and end of a character string may be defined according to the direction of reading (e.g. left to right for English, right to left for Arabic).

It will be appreciated that the apparatus may be configured to enable two or more iterations.

The selected particular extension character string is denoted as the base character string for the subsequent iteration level or is selected as an input character string based on a combination of one or more of:
a terminating character (a space or terminating punctuation mark such as a full stop, exclamation mark) being entered;
a selection gesture being performed (e.g. a single tap could indicate selection as an input character, a double tap could indicate denotation as the base character string and a swipe could indicate both selection as an input character and denotation as the base character string); and
a selection key (e.g. enter key or return key) being activated.

The apparatus may be configured to:
use the number of possible extension character strings associated with the base character strings to determine whether or not to iteratively process the actions.

The apparatus may be configured to:
use the number of characters in the received character string to determine whether or not to iteratively process the actions.

The apparatus may be configured to form a textual message comprising one or more selected input character string. The textual message may be comprise for example a combination of one or more of a text message, an SMS message, an MMS message, an email, a search entry, a text document, a twitter post, a status update, a blog post, a calendar entry and a web address.

Selection of the extension words may be enabled by displaying the extension words on a display screen. For example, they may be displayed in at least one of an array and a list (which may or may not be scrollable).

The user interface may comprise a combination of one or more of a touchpad, a touch-screen, a mouse, a keyboard, a joystick, a wand, a remote controller, a button, a motion detector, a position detector, a scriber and an accelerometer.

The apparatus or processor may be incorporated into an electronic device. The apparatus may be the (portable) electronic device. The electronic device which may or may not be portable may comprise, for example, a laptop computer, a desktop computer, a mobile phone, a Smartphone, a monitor, a personal digital assistant or a digital camera.

Corresponding computer programs for implementing one or more of the methods/apparatus disclosed are also within the present disclosure and encompassed by one or more of the described embodiments.

In a second aspect there is provided a method, the method comprising:
denoting, as a base character string, a received character string entered using a user interface of an electronic device; and
iteratively performing the actions of:
   determining one or more extension character strings associated with the base character string such that the one or more extension character strings comprise the denoted base character string and one or more respective additional characters;
   providing one or more said extension character strings for selection;
   enabling selection of a particular determined extension character string; and
   denoting the selected particular extension character string as the base character string for the subsequent iteration level; or
   selecting the particular determined extension character string as an input character string.

In a third aspect there is provided a computer program, the computer program comprising computer code configured to:
denote, as a base character string, a received character string entered using a user interface of an electronic device; and
iteratively perform the actions of:
   determining one or more extension character strings associated with the base character string such that the one or more extension character strings comprise the denoted base character string and one or more respective additional characters;
   providing one or more said extension character strings for selection;
   enabling selection of a particular determined extension character string; and
   denoting the selected particular extension character string as the base character string for the subsequent iteration level; or
   selecting the particular determined extension character string as an input character string.

The computer program may be stored on a storage media (e.g. on a CD, a DVD, a memory stick or other non-transitory media). The computer program may be configured to run on a device or apparatus as an application. An application may be run by a device or apparatus via an operating system.

In a fourth aspect there is provided an apparatus, the apparatus comprising
a means of denoting configured to denote, as a base character string, a received character string entered using a user interface of an electronic device; and
a means of performing configured to iteratively perform the actions of:
   determining one or more extension character strings associated with the base character string such that the one or more extension character strings comprise the denoted base character string and one or more respective additional characters, and providing one or more said extension character strings for selection;
   enabling selection of a particular determined extension character string; and
   denoting the selected particular extension character string as the base character string for the subsequent iteration level; or
   selecting the particular determined extension character string as an input character string.

In a fifth aspect there is provided a method, the method comprising:
denoting, as a base character string, a received character string entered using a user interface of an electronic device; and
iteratively performing the actions of:
   determining one or more extension character strings associated with the base character string such that each of the one or more extension character strings
   comprises the denoted base character string and one or more respective additional characters, or
   is semantically related to the denoted base character string;
   providing one or more said extension character strings for selection;
   enabling selection of a particular determined extension character string; and
   denoting the selected particular extension character string as the base character string for the subsequent iteration level; or
   selecting the particular determined extension character string as an input character string.

In a sixth aspect there is provided a computer program, the computer program comprising computer code configured to:
denote, as a base character string, a received character string entered using a user interface of an electronic device; and
iteratively perform the actions of:
   determining one or more extension character strings associated with the base character string such that each of the one or more extension character strings at least
   comprises the denoted base character string and one or more respective additional characters, or
   is semantically related to the denoted base character string;
   providing one or more said extension character strings for selection;
   enabling selection of a particular determined extension character string; and
   denoting the selected particular extension character string as the base character string for the subsequent iteration level; or
   selecting the particular determined extension character string as an input character string.

In a seventh aspect there is provided an apparatus comprising:
at least one processor; and
at least one memory including computer program code,
the at least one memory and the computer program code configured to, with the at least one processor, cause the apparatus to perform at least the following:
denote, as a base character string, a received character string entered using a user interface of an electronic device; and
iteratively perform the actions of:
   determining one or more extension character strings associated with the base character string such that each of the one or more extension character strings at least
      comprises the denoted base character string and one or more respective additional characters, or
      is semantically related to the denoted base character string;
   providing one or more said extension character strings for selection;
   enabling selection of a particular determined extension character string; and
   denoting the selected particular extension character string as the base character string for the subsequent iteration level; or
   selecting the particular determined extension character string as an input character string.

It will be appreciated that each of the extension character strings may either comprise the denoted base character string and one or more respective additional characters (e.g. base character string ‘pea’ and corresponding extension character string ‘peach’), or be semantically related to the denoted base character string (e.g. base character string ‘leaf’ and corresponding extension character string ‘leaves’, base character string ‘forgettable’ and corresponding extension character string ‘forgot’), or comprise the denoted base character string and one or more respective additional characters, and be semantically related to the denoted base character string (e.g. base character string ‘forget’ and corresponding extension character string ‘forgettable’).

Character strings which have a semantic relationship may include at least one of word character strings with the related meanings, synonyms (e.g. ‘big’, ‘enormous’, ‘tall’), words with a related etymology (e.g. ‘octo’, ‘octopus’, ‘octagon’), and word character strings with a common root or stem (e.g. ‘managing’, ‘manage’, ‘managed’).

It will be appreciated that the determination of extension character strings may be based on a measure of the semantic relationship and a measure of the similarity of the candidate extension character strings and the base character strings. For example, if the base character string was ‘leaf’ a determined extension character string may be ‘leaves’ as there are a number of common characters (the number and/or proportion of common characters giving a measure of the similarity) and the two words are closely semantically related. However, the character string ‘page’ may not be determined to be, or provided as, an extension character string because, although the word ‘page’ is semantically related to the word base character string ‘leaf’, there are no common characters (i.e. a low level of similarity between the two character strings).

Determining semantically related words may make text entry for languages which have significant stem changes for inflected versions of a word more intuitive. For example, the Finnish word Pidempr (meaning longer) is semantically related to, but has different characters to, the Finnish word ‘Pitka’ (meaning long). An embodiment may be configured such that a user may chose the word ‘Pitka’ in one iteration and be presented by a list of corresponding extension character strings comprising the word Pidempr.

In an eighth aspect there is provided an apparatus, the apparatus comprising:
at least one processor; and
at least one memory including computer program code,
the at least one memory and the computer program code configured to, with the at least one processor, cause the apparatus to perform at least the following:
denote, as a base character string, a received character string entered using a user interface of an electronic device; and
iteratively perform the actions of:
   determining one or more extension character strings associated with the base character string such that the one or more extension character strings is based upon the denoted base character string and one or more other characters;
   providing one or more said extension character strings for selection;
   enabling selection of a particular determined extension character string; and
   denoting the selected particular extension character string as the base character string for the subsequent iteration level; or
   selecting the particular determined extension character string as an input character string.

The extension character strings may be based on the denoted base character string by being semantically related to the base character string. The extension character strings may be based on the denoted base character string by being having common characters.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 depicts an embodiment comprising a number of electronic components, including memory, a processor and a communication unit.

FIG. 2 illustrates an embodiment comprising a touch-screen.

FIG. 3a-c illustrates the views of the touch-screen as a user inputs a message.

FIG. 4a illustrates a further embodiment comprising a physical keyboard and touchpad.

FIG. 4b-d illustrates the views of the screen as a user inputs a message.

FIG. 5a-f depicts the views of a screen of a further embodiment as a user inputs a message.

FIG. 6 depicts a further embodiment configured to enable ambiguous character string entry.

FIG. 7 depicts a flow diagram describing the method used to enter an input character string.

FIG. 8 illustrates schematically a computer readable media providing a program according to an embodiment of the present invention.

### DESCRIPTION OF EXAMPLE ASPECTS/EMBODIMENTS

For the sake of convenience, different embodiments depicted in the figures have been provided with reference numerals that correspond to similar features of earlier described embodiments. For example, feature number 1 can also correspond to numbers 101, 201, 301 etc. These numbered features may not have been directly referred to within the description of these particular embodiments. These have still been provided in the figures to aid understanding of the further embodiments, particularly in relation to the features of similar described embodiments.

It is common for a user to employ an electronic device to enter characters via a user interface, for example, to write a text message, enter a search term, or write a letter. In order to enter characters, conventional user interfaces have utilised keys which correspond to one or more characters. When the user presses a key, a corresponding character is entered. This may require a large number of key presses to enter a word and may be an onerous requirement on the user (particularly when the keyboard is small).

Other character input user interfaces are configured to disambiguate ambiguous key sequences entered by the user (e.g. using predictive text). This may reduce the number of key presses but the user may be presented with a large number of character strings which correspond to the ambiguous key sequence. Deciding which character string to select may be tedious particularly when the user must interact with the device to see all of the available character strings (e.g. by scrolling through a list, or by changing the mode of the device). It may be advantageous to provide a user interface wherein the number of possible character strings corresponding to an entered character sequence is reduced, and the number of keystrokes required to enter the entered character sequence is also reduced.

Example embodiments contained herein may be considered to provide a way of iteratively building up a desired input character string by iteratively adding one or more further additional characters to the previously entered character string until the desired character string is complete. By dividing the process into a number of iterations, the choice of additional characters may be minimised for each iteration stage.

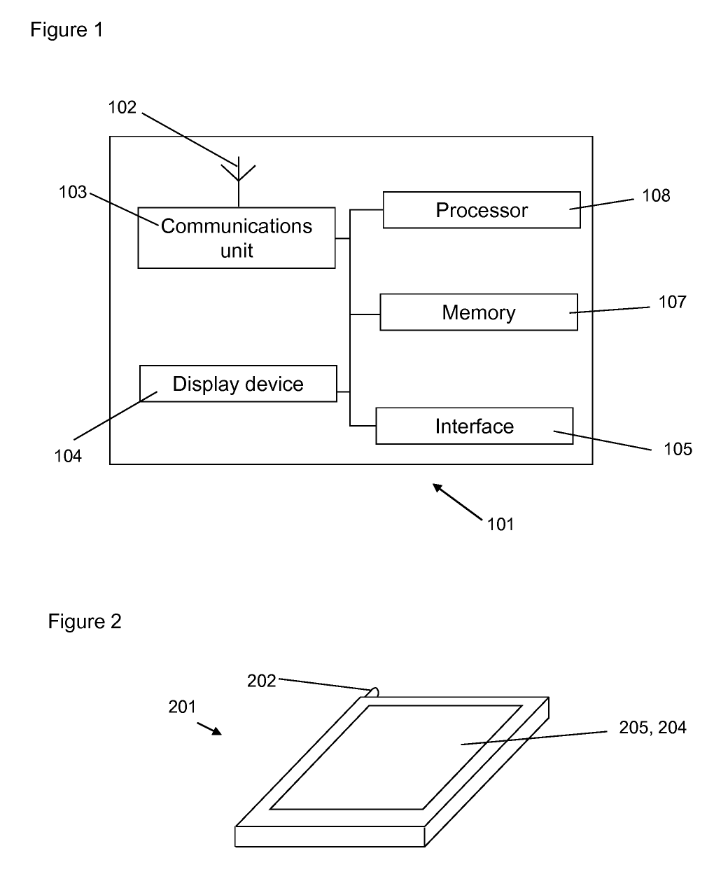

FIG. 1 depicts an apparatus (101) of an embodiment, such as a mobile phone. In other embodiments, the apparatus (101) may comprise a module for a mobile phone (or PDA or audio/video player), and may just comprise a suitably configured memory (107) and processor (108).

The embodiment of FIG. 1, in this case, comprises a display device (104) such as, for example, a Liquid Crystal Display (LCD) or touch-screen user interface. The apparatus (101) of FIG. 1 is configured such that it may receive, include, and/or otherwise access data. For example, this embodiment (101) comprises a communications unit (103), such as a receiver, transmitter, and/or transceiver, in communication with an antenna (102) for connecting to a wireless network and/or a port (not shown) for accepting a physical connection to a network, such that data may be received via one or more types of networks. This embodiment comprises a memory (107) that stores data, possibly after being received via antenna (102) or port or after being generated at the user interface (105). The processor (108) may receive data from the user interface (105), from the memory (107), or from the communication unit (103). It will be appreciated that, in certain embodiments, the display device (104) may incorporate the user interface (105). Regardless of the origin of the data, these data may be outputted to a user of apparatus (101) via the display device (104), and/or any other output devices provided with apparatus. The processor (108) may also store the data for later user in the memory (107). The memory (107) may store computer program code and/or applications which may be used to instruct/enable the processor (108) to perform functions (e.g. read, write, delete, edit or process data).

FIG. 2 depicts an embodiment of the apparatus comprising a portable electronic device (201), e.g. such as a mobile phone or tablet computer, with a user interface comprising a touch-screen user interface (205, 204), a memory (not shown), a processor (not shown) and an antenna (202) for transmitting data (e.g. a textual message comprising entered characters). The portable electronic device is configured to allow the user to enter characters by interacting with a virtual keyboard (when the device is configured to be in a character input mode). It will be appreciated that in other suitably adapted embodiments characters may be entered using a mouse, or a physical keypad.

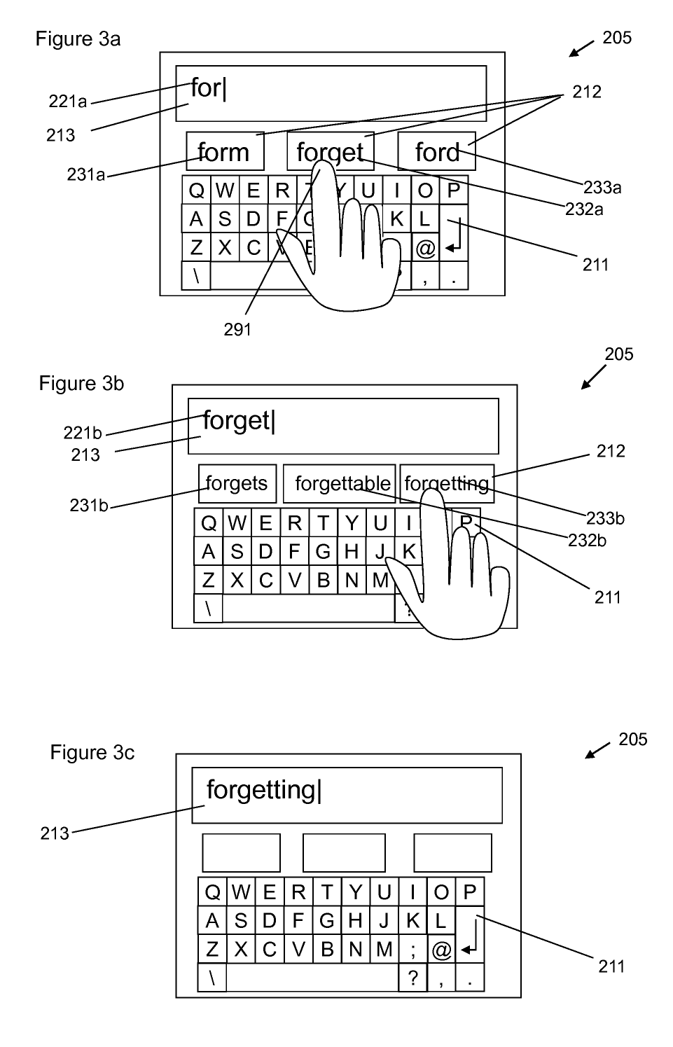

FIG. 3a-c illustrates a series of views of the touch-screen user interface (205) of the embodiment of FIG. 2 when the device (201) is in use. In this example, the user wants to write a message comprising the word ‘forgetting’ and send it, via a network (e.g. mobile phone network, internet, LAN or Ethernet), to a friend. To facilitate the inputting such a message, this embodiment has an input mode wherein the touch-screen user interface (205) is divided into three regions: a key user interface (211) which in this case is a virtual keyboard having, for example, letter keys a-z arranged according to the QWERTY layout and punctuation keys corresponding to punctuation mark characters; a selection region (212) which is responsive to touch and is configured to display one or more determined extension character strings for selection; and an entered character region (213). The entered character region (213) of the touch-screen user interface (205) is configured to display an arrangement of the characters, or character strings, already input into the device (e.g. via the keyboard and/or selection region (212)). The key user interface (211) region displays a number of touch buttons or keys which the user can activate by pressing in order to enter a corresponding character.

In FIG. 3a, the user has typed in the character string ‘for’ using the keys of the virtual keyboard key user interface (211). For this embodiment, characters input using the virtual keyboard are entered directly into the entered character region (213) as the characters are typed. In response to characters being entered, the apparatus is configured to denote, as a base character string (221a), the received entered character string (which in this case is the character string ‘for’).

The apparatus is then configured to determine one or more extension character strings (e.g. ‘form’, ‘forget’ and ‘ford’ as shown in FIG. 3a) associated with the base character string such that the one or more extension character strings comprise the denoted base character string and one or more respective additional characters.

In this case, each of the determined extension character strings is a complete character string (e.g. a recognised word) present in a predictive text dictionary to which the apparatus has access.

However, those (longer) complete character strings which could be entered using two or more iterations (i.e. via an intermediate extension character string) are not provided in the first iteration. That is, each longer complete character string (e.g. ‘forgetting’, ‘formation’) which comprises a shorter complete character string (e.g. ‘forget’, form), the shorter complete character string comprising the base character string (‘for’) and additional characters, is not provided for selection. This means that the extension character strings provided for selection are the shortest complete extension character strings, as each shortest complete extension character does not comprise any other complete extension character string and one or more additional characters. Therefore, what are presented for selection are the minimum characters which would make up a full/complete word. But variations of that word may not be provided.

Restricting the number of determined extension characters in this way reduces the number of extension strings provided for selection. Reducing the number of character may make it easier for the user to find and select the desired extension character string.

It will be appreciated that selecting criteria for determining extension character strings, such that entering an input string is efficient and intuitive, may be a compromise between reducing the number of iterations required and the number of extension word provided for selection at each stage. It will be appreciated therefore that other example embodiments may determine extension character strings using less restrictive criteria (e.g. in order to reduce the number of iterations), or determine extension character strings using more restrictive criteria (e.g. to reduce the number of extension character strings determined at each iteration). It will be appreciated that other example embodiments may adjust the criteria for determining extension character strings at each iteration, for example, such that the number of determined character strings is close to a predetermined number.

In this example, the determined extension character strings include the words ‘form’ (231a), ‘forget’ (232a) and ‘ford’ (233a). The apparatus is configured to provide one or more said extension character strings (the full words/the primary words in these embodiments) for selection by displaying them, as icons (212), in the selection region (212) of the touch-screen user interface (205).

In this case, the device is configured to display three extension character strings (231-233) for selection. In the event that more that three extension character strings are determined, the apparatus is configured to determine which of these to display for selection on the basis of user statistics. That is, extension strings which have been more commonly used in the past will be displayed in preference to those extension strings which have been less commonly used. It will be appreciated that other embodiments may determine which extension character strings are provided for selection on the basis of other criteria (e.g. how many complete character strings comprise the extension string, prediction based on other entered words in the sentence).

In this example, the user wishes to enter the word ‘forgetting’ and so selects the extension word which forms part (e.g. the first part) of the desired word, in this case ‘forget’ (232a), by selecting the corresponding icon of the selection region on the touch-screen user interface (204) using his finger (291). This is depicted in FIG. 3a.

In response to the user selecting the extension character string, the apparatus is configured to denote the selected particular extension character string as the base character string for the subsequent iteration level. In this case, the particular determined extension character string (221 b) is entered into the entered character region (213) of the touch screen user interface (205). This is depicted in FIG. 3b. For this example, this completes a first iteration and initiates the second iteration.

For a second iteration, the apparatus is configured to determine further extension character strings based on the updated denoted base character string (which in this situation is now ‘forget’ (221b), as depicted in FIG. 3b). As for the previous iteration, each of the determined extension character strings is a complete character string stored in the predictive text dictionary. In this case the determined character strings are determined to be ‘forgets’ (231b), ‘forgettable’ (232b) and ‘forgetting’ (233b). As one of the determined character strings is the desired word, the user selects the icon (212) corresponding to the desired word extension character string ‘forgetting’ (233b).

As the desired word does not form part of any other complete character strings of the predictive text dictionary, the selected particular extension character string is not denoted as the base character string for a subsequent iteration level. However, the particular determined extension character string is selected as an input character string and input into the entered character region (213) of the touch-screen user interface (205). The second iteration is thereby completed. The user can continue to enter further characters using the key user interface (211).

It will be appreciated that other example embodiments may be configured to enable the user to select the particular determined character string as an input string in different ways. For example, the user may select the particular determined character string as an input string by entering a terminating character (e.g. full stop, exclamation mark, question mark or space character). Alternatively/in addition, the apparatus may comprise a selection key (e.g. an ‘enter’ or ‘return’ key) configured to enable the user to select the selected extension character as an input character string. Alternatively/in addition, the apparatus may enable the user to select the selected extension character as an input character string by using a selection gesture (e.g. a selection gesture may be a swipe, whereas a tapping gesture would indicate that the user wished only to denote the extension character string as the base character string).

It will be appreciated that for this embodiment, for each iteration, a maximum of three extension characters were provided/presented for selection. It will be appreciated that, for other example, embodiments any number of extension characters may be provided for selection. It will be appreciated that extension characters may be displayed according to a hierarchy. The hierarchy may be dependent on, for example, (global/regional/personal) usage statistics, number of complete strings comprising the extension word, number of letters in the extension character string and alphabetical order.

It will be appreciated that other example embodiments may determine extension words which are semantically related to the base character string instead of, or in addition to, extension words which comprise the denoted base character string and one or more respective additional characters. For example, in the situation depicted in FIG. 3c, the extension strings ‘forgets’, ‘forgettable’ may be determined as these word extension strings are semantically related to the word base character string ‘forgetting’. It will be appreciated that the semantic relationships between the words may be stored in the predictive text dictionary. For example, each word stored in the predictive text dictionary may correspond to a list of semantically related words. The predictive text dictionary may comprise information giving a measure of the semantic relationship between two character strings (e.g. the dictionary may comprise information denoting that the word ‘octagon’ is semantically related to the prefix ‘octo’ to a lesser degree than to the word ‘octagons’).

It will be appreciated that, for other example embodiments, an iteration may be initiated by selecting an already entered character string. For example, an embodiment may be configured such that the user can select an already entered word character string anywhere in the text and denote it as a base character string. The device may then be configured to determine one or more extension character strings associated with the base character string such that each of the one or more extension character strings at least
comprises the denoted base character string and one or more respective additional characters, or
is semantically related to the denoted base character string.

In this way the user may be able to adapt the already entered word in a post-entry correction phase.

It will be appreciated that, for other example embodiments, the determination of extension character strings may be based on both the semantic relationship and a measure of the similarity of the candidate extension character strings and the base character strings. For example, if the base character string was ‘leaf’ a determined extension character string may be ‘leaves’ as there are a number of common characters and the two words are semantically related. However, the character string ‘page’ may not be determined to be an extension character string because, although the word ‘page’ is semantically related to the word base character string ‘leaf’, there are no common characters.

It will be appreciated that where the extension words comprise the base extension string and respective additional characters, the display may provide only the additional characters for selection (i.e. rather than the entire extension character string). For example, in the situation depicted in FIG. 3b, the selection region may be configured to show the respective additional characters (e.g. ‘s’, ‘table’ and ‘ting’ rather than ‘forgets’, ‘forgettable’ and ‘forgetting’).

It will be appreciated that, for other example embodiments, in a subsequent iteration a determined character string which was provided for selection and not selected in a previous iteration may not be again provided for selection. That is, if the user has declined an opportunity to select a provided extension character string, it may be assumed that the user does not wish to select that extension character string. This may allow the list of provided extension character strings to be focussed on those character strings which the user may wish to select.

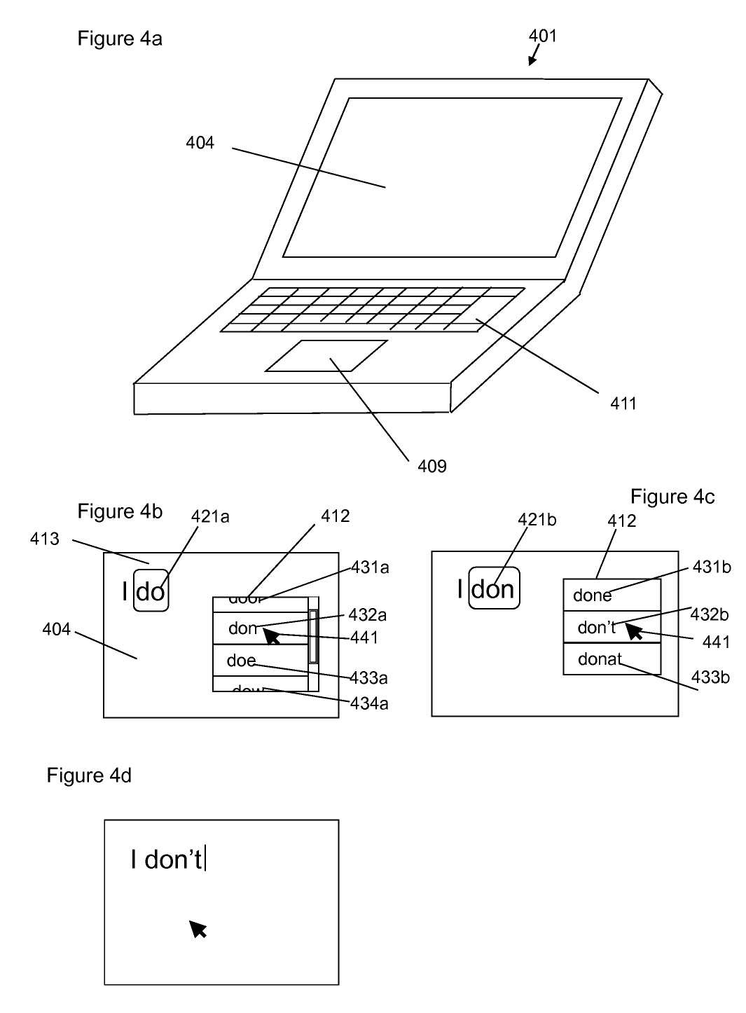

FIG. 4a illustrates a further embodiment (401) of an apparatus such as a personal digital assistant device comprising a user interface, the user interface comprising a touchpad (409), a key user interface (411) which, in this case, is a physical keyboard. This embodiment further comprises a screen (404); a processor and memory (not shown). Unlike the apparatus of FIG. 2 in which the user interface and the display functions were both provided by a touch-screen, in this embodiment these functions are provided by a screen (404), a physical keyboard (411) and a touchpad (409). In this example, the user wishes to type a message comprising the words ‘I don't know’.

FIGS. 4b-4d depict the user interface/screen as he is entering the character string word ‘don't’ as part of the message.

With regard to FIGS. 4b, in this case, the user has entered the character string ‘do’ using the key user interface (411) by pressing the corresponding physical keys. The apparatus is, in this case, configured to receive the entered character string and denote, as a base character string, the received character string. In this case, each character string is delimited by spaces. So, in this case, the entered character string ‘do’ is denoted as the base character string. It will be appreciated that the previously entered word ‘I’ is a different character string comprising a single letter character.

In this embodiment the apparatus is configured to construct the desired character string in iterative stages, wherein at each iterative stage, further additional characters are added to an initial base character string until the desired character string is complete.

For a first iteration, the apparatus is configured to determine one or more extension character strings associated with the base character string, ‘do’ (421a), such that the one or more extension character strings comprise the denoted base character string and one or more respective additional characters. Unlike the previous case, where all of the extension character strings were complete character strings (or full/primary/root words), in this case, the apparatus is configured to determine extension character strings comprising:
common character strings, wherein each the common character string is common to multiple complete character strings (and may not correspond to complete character strings); and
shortest complete extension character strings, wherein each shortest complete extension character string does not comprise another complete extension character string and additional characters.

Limiting the determined extension characters to common character strings and shortest complete extension character strings may limit the number of extension character strings available for selection and may therefore mitigate the need for a long list of candidates.

In this case, the apparatus is configured to provide the one or more extension character strings for selection by displaying the extension character strings in a list selection region (412) on the screen (404) of the device (401). The determined extension character strings in the situation depicted in FIG. 4b comprises the words:
‘door’ (431a) which is a shortest complete extension character string as it is itself a complete character string;
‘don’ (432a) which is a common character string as it forms part of the compete strings ‘don't’, ‘done’ and ‘donkey’;
‘doe’ (433a) which is a common character string as it forms part of the complete strings ‘does’ and ‘doesn't’, and is a shortest complete extension character string as it is itself a complete character string; and
‘dow’ (434a) which is a common character string as it forms part of the compete strings ‘down’, ‘dowel’ and ‘dowry’.

In this case, in order to enable the selection of the determined extension character string, all of the determined extension character strings are displayed in a scrollable list selection region (412). The user can interact with the scrollable list selection region via a cursor (441) controlled by the touch pad (409).

In this case, the user wishes to enter the character string ‘don't’ and therefore selects, using the cursor (441) with the touch pad (409), the extension character string ‘don’ (432a) which forms part of the desired character string. In response to the selection the apparatus is configured to denote the selected particular extension character string as the base character string (421b) for the subsequent iteration level. This completes the first iteration.

For the second iteration, the apparatus is configured to determine further extension character strings comprising the denoted base character string ‘don’ (421b). Using the same determination as before, the apparatus determines the shortest complete character strings, ‘done’ (431b) and ‘don't’ (432b), and a common character string ‘donat’ (433b) (common to ‘donating’ and ‘donates’). These are displayed in the selection region (412) of the screen.

In this case, the user wishes to enter the character string ‘don't’ and therefore selects, using the cursor (441) with the touch pad (409), the extension character string ‘don't’ (432b) which forms part of the desired character string. In response to the selection the apparatus is configured to denote the selected particular extension character string as the base character string for the subsequent iteration level. In addition, the particular determined extension character string is selected as an input character string and input into the entered character region (413) of the screen. This completes the second iteration.

In this case, the apparatus is unable to determine any extension character strings comprising the denoted base character string, ‘don't’, and additional characters. When there are no determined extension character strings the apparatus is configured to remove the selection region. The user is then free to either enter a new word or manually append letters to the input character string using the physical keyboard (411).

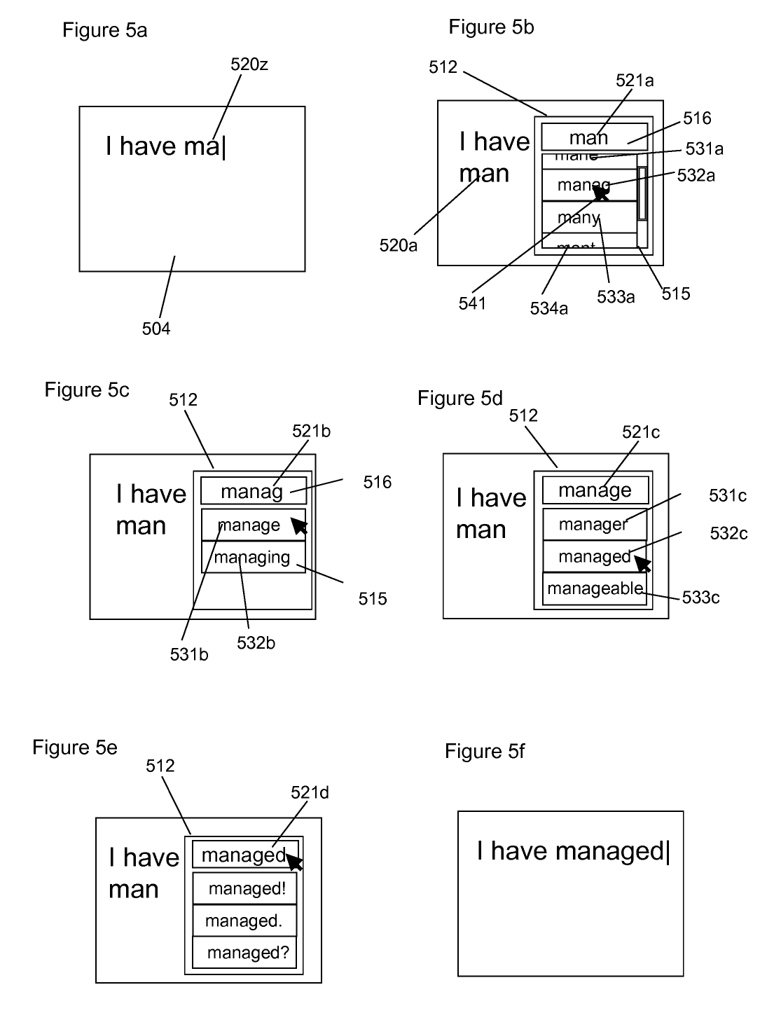

FIGS. 5a-5f depict the screen of a further embodiment as the user is entering the word ‘managed’ as part of the message ‘I have managed it’. Like the embodiment of FIG. 4a, this embodiment comprises a screen and a physical keyboard. In this case however, the cursor is controlled using a mouse (not shown) rather than with a touch pad.

In this embodiment the apparatus is configured to construct a desired character string in iterative stages, wherein at each iterative stage, further additional characters are added to an initial base character string until the desired character string is complete.

FIGS. 5a depicts the screen (504) as the user is entering the textual message. In this case the user has entered the character strings ‘I have ma’ using the key user interface by pressing the corresponding physical keys. The apparatus is, in this case, configured to receive the last entered character string and denote, as a base character string, the received character string. Like the previous embodiment, for this embodiment, each character string is delimited by spaces. In this case, the apparatus is not configured to enter into the iterative extension character selection mode until the number of determined extension characters falls below a predetermined number, which in this case is ten. It will be appreciated that this predetermined number may be different for different embodiments. In situation depicted in FIG. 5a, as more that ten extension characters correspond to the base character ‘ma’ (520z) the iterative extension character selection mode is not entered.

It will be appreciated that other embodiments may allow the user to enter the iterative extension character selection mode manually (e.g. by pressing an iterative extension character selection mode key). It will be appreciated that other embodiments may use the number of characters in the received character string to determine whether or not to iteratively process the actions (e.g. in an iterative extension character selection mode).

FIG. 5b depicts the screen when the user has entered a further character to the character string using the physical keyboard. The apparatus is, in this case, configured to receive the entered character string, ‘man’ (520a), and denote, as a base character string (521a), the received character string. The apparatus is then configured to determine corresponding extension character strings comprising the base character string and one or more additional characters. In this case the apparatus determines that the number of determined extension character strings is less than ten and changes the mode of the device to an iterative extension character selection mode. The determination of the extension strings forms the first action of the first iteration.

In this mode the selectable extension character strings are displayed in a pop-up selection region (512) of the screen (504). In this embodiment, a cursor (541) is provided to enable the user to interact with the pop-up selection region (512) (although this may not be provided in other embodiments). The pop-up selection region comprises an extension character string region (515) and a base character region (516). Selecting an extension character string from the extension character string region (515) denotes the extension string as the base character string and enables a further iteration to be initiated. Selecting the base character string from the base character selection region (516) allows the base character to be selected as input into the entered character region, and the extension character selection mode to be exited (returning the device to a conventional character entry mode).

Like the previous embodiment, this embodiment is configured to determine extension character strings comprising:
common character strings, wherein each of the common character strings is common to multiple complete character strings (and may not correspond to complete character strings); and
shortest complete extension character strings, wherein each shortest complete extension character string does not comprise another complete extension character string and additional characters.

In this case, the apparatus is configured to provide the one or more extension character strings for selection by displaying the extension character strings in a list on the screen of the device. The determined extension character strings in this case comprises the words:
‘mane’ (531a) which is a shortest complete extension character string as it is itself a complete character string;
‘manag’ (532a) which is a common character string as it forms part of the compete strings ‘manager’, ‘managing’, ‘manageable’ and ‘managed’;
‘many’ (533a) which is a shortest complete extension character string as it is itself a complete character string; and
‘mant’ (534a) which is a common character string as it forms part of the compete strings ‘mantra, ‘mantis’ and ‘mantle’.

In this case, in order to enable the selection of the determined extension character string, all of the determined extension character strings are displayed in a scrollable list selection region (512). The user can interact with the scrollable list selection region via a cursor (541) controlled by a mouse (not shown).

In this case, the user wishes to enter the character string ‘managed’ and therefore selects, using the cursor (541) with the mouse, the extension character string ‘manag’ (532a) which forms part of the desired character string. This is depicted in FIG. 5b. In response to the selection the apparatus is configured to denote the selected particular extension character string as the base character string for the subsequent iteration level.

This completes the first iteration. Unlike the previous embodiment, selected extension character strings are not selected as an input character string by default.

For the second iteration, the apparatus is configured to determine further extension character strings comprising the denoted base character string ‘manag’ (521b). Using the same determination as before, the apparatus determines the shortest complete extension character strings, ‘manage’ (531b) and ‘managing’ (532b). These are displayed in the selection region (512) of the screen (504) as depicted in FIG. 5c.

In this case, the user wishes to enter the character string ‘managed’ and therefore selects, using the cursor (541) with the mouse, the extension character string ‘manage’ (531b) which forms part of the desired character string. In response to the selection, the apparatus is configured to denote the selected particular extension character string as the base character string for the subsequent iteration level. This completes the second iteration.

For the third iteration, the apparatus is configured to determine further extension character strings comprising the denoted base character string ‘manage’. Using the same determination as before, the apparatus determines the shortest complete extension character strings, ‘manager’ (531c), ‘managed’ (532c) and ‘manageable’ (533c). These are displayed in the selection region (512) of the screen (504) as depicted in FIG. 5d.

In this case, the user wishes to enter the character string ‘managed’ and therefore selects, using the cursor (541) with the mouse, the extension character string ‘managed’ (532c). In response to the selection, the apparatus is configured to denote the selected particular extension character string as the base character string for a subsequent iteration level. This completes the third iteration.

In response to the completion of the third iteration, the apparatus is configured to determine further extension character strings comprising the denoted base character string ‘managed’ (521d). Using the same determination as before, the apparatus determines the shortest complete extension character strings, ‘managed.’ (531d), ‘managed?’ (532d) and ‘managed!’ (533d) (that is, the denoted base character string ‘managed’ followed by respective punctuation marks). These are displayed in the selection region (512) of the screen (504) as depicted in FIG. 5e.

In this case, the user wishes to select the extension character string ‘managed’, which has been denoted as the base character string, as an input character string. To select the denoted base character string (521d) as an input character string, the user selects the base character string selection region (516) using the cursor (541) as depicted in FIG. 5e. This allows the base character to be input into the entered character region, and the extension character selection mode to be exited (returning the device to a conventional character entry mode) as illustrated in FIG. 5f. The user is then free to either enter a new word or manually append letters to the input character string using the physical keyboard.

For the above described examples, the initially entered character string (e.g. ‘for’ in FIG. 3a) is unambiguous (each character is unambiguously defined). It will be appreciated that for other example embodiments, the entered character string could be ambiguous (e.g. correspond to multiple unambiguous character strings of the same length as the entered character string). For example, an embodiment having multiple characters associated with a single key (e.g. having an ITU-T E.161 keyboard) may enable the user to enter an ambiguous character string by activating a sequence of keys (e.g. each key being activated once). In addition/alternatively, a device may be configured to associate the simultaneous (e.g. mistaken) activation of multiple keys (each key being associated with a character) with an ambiguous key stroke, the ambiguous key stroke corresponding to any of the characters associated with the activated multiple keys.

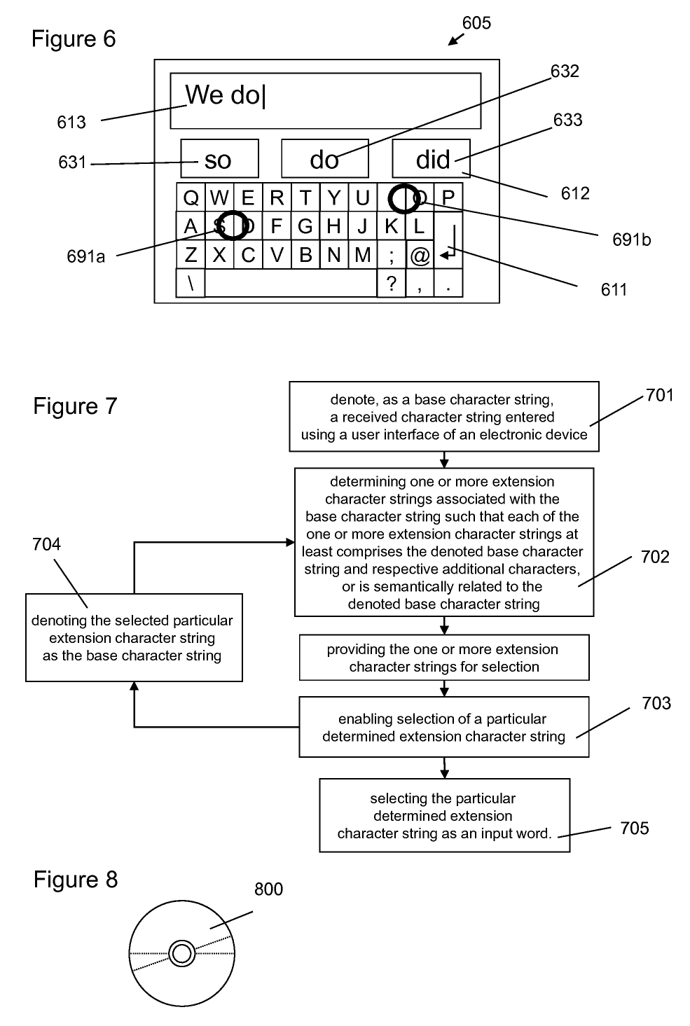

For example, a further embodiment (605) configured to enable ambiguous character string entry is depicted in FIG. 6. This embodiment is similar to the embodiment of FIG. 3a, having a key user interface (611); a selection region (612) which is responsive to touch and is configured to display one or more determined extension character strings for selection; and an entered character region (613). This embodiment is configured to recognise simultaneously pressing two (or more) keys as an ambiguous key stroke associated with all of the characters corresponding to the pressed keys. As depicted in FIG. 6, pressing the letter keys ‘s’ and ‘d’ simultaneously (at position 691a) and then ‘i’ and ‘o’ simultaneously (at position 691b) results in an ambiguous entered character string wherein the first letter character is ‘s’ or ‘d’ and the second letter character is ‘i’ or ‘o’.

For embodiments which allow ambiguous character strings to be entered (and denoted as a base character string), it will be appreciated that the extension character strings determined may comprise any of the unambiguous character strings corresponding to the ambiguous entered base character string. In the example depicted in FIG. 6, for the ambiguous entered character string wherein the first letter character is ‘s’ and ‘d’ and the second letter character is ‘i’ or ‘o’, the determined extension character strings may comprise the word character strings ‘did’ (631), ‘so’ (632) and ‘do’ (633).

Although for the previously described embodiments the initial received character string was entered character by character using a key user interface, it will be appreciated that the received character string could be a series of characters recognised using, for example, hand-writing recognition. Furthermore, character entry may be non-English and may facilitate the entry of one or more of, for example, Greek, Arabic, Cyrillic and other alphabet characters; and Japanese, Chinese, Korean and other graphic characters (e.g. using transcription systems such as pinyin or Zhuyin fuhao).

It will be appreciated that using iterative stages to build up the desired character string enables the user interface to be developed by adjusting the number of extension character strings provided at each stage and the number of iterations. That is, more character strings at each stage may reduce the number of required iterations, whereas less character strings at each stage may increase the number of required iterations. Providing for optimisation one or more of these two factors (number of provided character strings, number of iterations) may allow the user interface to be more efficient (e.g. mitigating the need to scroll to the desired provided character string) and intuitive (e.g. as the user is not overwhelmed by too many candidate words). It may also allow the screen size to be reduced.

FIG. 7 shows a flow diagram illustrating the entering of an input character string and is self-explanatory.

FIG. 8 illustrates schematically a computer/processor readable media 800 providing a program comprising computer code which implements one or more of the aforementioned embodiments. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
denote, as a base character string, a received character string entered using a user interface of an electronic device; and
iteratively perform the actions of:
determining one or more extension character strings associated with the base character string such that each of the one or more extension character strings at least
comprises the denoted base character string and one or more respective additional characters, or
is semantically related to the denoted base character string;
providing one or more said extension character strings for selection;
enabling selection of a particular determined extension character string; and
denoting the selected particular extension character string as the base character string for the subsequent iteration level; or
selecting the particular determined extension character string as an input character string.

2. The apparatus of claim 1, wherein a said extension character string comprises at least one of:
a word; a sentence; a phrase; a free morpheme; a bound morpheme; a root character string; a stem character string; an affix; a prefix; and a suffix.

3. The apparatus of claim 1, wherein a said extension character string comprises:
a complete character string, each complete character string being stored in a dictionary.

4. The apparatus of claim 1, wherein a said extension character string provided for selection comprises:
a shortest complete extension character string, wherein each shortest extension complete character string does not comprise any other complete extension character string and one or more additional characters.

5. The apparatus of claim 1, wherein a said extension character string comprises:
a common character string, the common character strings being common to at least two complete character strings stored in a dictionary.

6. The apparatus of claim 1, wherein the base character string forms the beginning characters of each corresponding determined extension character string.

7. The apparatus of claim 1 wherein the character comprises a combination of one or more of a letter character, a graphic character, a syllable, a diacritical mark, an emoticon, and a punctuation mark.

8. The apparatus of claim 1 wherein the selected particular extension character string is denoted as the base character string for the subsequent iteration level or is selected as an input character string based on a combination of one or more of:
a terminating character being entered;
a selection gesture being performed; and
a selection key being activated.

9. The apparatus of claim 1, wherein selection of the extension words is enabled by displaying the extension words on a display screen.

10. The apparatus of claim 1, wherein the apparatus is configured to enable two or more iterations.

11. The apparatus of claim 1, wherein the apparatus is configured to:
use the number of possible extension character strings associated with the base character strings to determine whether or not to iteratively process the actions.

12. The apparatus of claim 1, wherein the apparatus is configured to:
use the number of characters in the received character string to determine whether or not to iteratively process the actions.

13. The apparatus of claim 1, wherein the user interface comprises a combination of one or more of a touchpad, a touch-screen, a mouse, a keyboard, a joystick, a wand, a remote controller, a button, a motion detector, a position detector, a scriber and an accelerometer.

14. The apparatus of claim 1 wherein the electronic device is a portable electronic device, a laptop computer, a desktop computer, a mobile phone, a Smartphone, a monitor, a personal digital assistant or a digital camera.

15. The apparatus of claim 1, wherein the input character string forms part of a textual message, a text message, an SMS message, an MMS message, an email, a search entry, a text document, a twitter post, a status update, a blog post, a calendar entry or a web address.

16. A method, the method comprising:
denoting, as a base character string, a received character string entered using a user interface of an electronic device; and
iteratively performing the actions of:
determining one or more extension character strings associated with the base character string such that each of the one or more extension character strings
comprises the denoted base character string and one or more respective additional characters, or
is semantically related to the denoted base character string;
providing one or more said extension character strings for selection;
enabling selection of a particular determined extension character string; and
denoting the selected particular extension character string as the base character string for the subsequent iteration level; or
selecting the particular determined extension character string as an input character string.

17. A computer program, the computer program comprising computer code configured to: denote, as a base character string, a received character string entered using a user interface of an electronic device; and
iteratively perform the actions of:
determining one or more extension character strings associated with the base character string such that each of the one or more extension character strings at least
comprises the denoted base character string and one or more respective additional characters, or
is semantically related to the denoted base character string;
providing one or more said extension character strings for selection;
enabling selection of a particular determined extension character string; and
denoting the selected particular extension character string as the base character string for the subsequent iteration level; or
selecting the particular determined extension character string as an input character string.
